(19) United States
(12) Patent Application Publication
(10) Pub. No.: US 2024/0329230 A1
(43) Pub. Date: Oct. 3, 2024

(54) SENSING METHOD, COMMUNICATION APPARATUS, MEDIUM, AND CHIP

(71) Applicant: HUAWEI TECHNOLOGIES CO., LTD., Shenzhen (CN)

(72) Inventors: Jia He, Chengdu (CN); Xianfeng Du, Chengdu (CN); Huang Huang, Shenzhen (CN)

(73) Assignee: HUAWEI TECHNOLOGIES CO., LTD., Shenzhen (CN)

(21) Appl. No.: 18/743,047

(22) Filed: Jun. 13, 2024

Related U.S. Application Data
(63) Continuation of application No. PCT/CN2022/140709, filed on Dec. 21, 2022.

(30) Foreign Application Priority Data
Dec. 27, 2021 (CN) 202111615249.X

(51) Int. Cl. G01S 13/76; G01S 13/88

(52) U.S. Cl. CPC G01S 13/765; G01S 13/887

(57) ABSTRACT

A terminal device first authenticates whether the terminal device has permission to sense a to-be-measured object. If the terminal device has sensing permission, the terminal device senses the to-be-measured object. If the terminal device has no sensing permission, the terminal device does not sense the to-be-measured object. In this way, privacy leakage of the to-be-measured object is prevented.

### CROSS-REFERENCE TO RELATED APPLICATIONS

This application is a continuation of International Application No. PCT/CN2022/140709, filed on Dec. 21, 2022, which claims priority to Chinese Patent Application No. 202111615249.X, filed on Dec. 27, 2021. The disclosures of the aforementioned applications are hereby incorporated by reference in their entireties.

### TECHNICAL FIELD

The present disclosure relates to the communication field, and more specifically, to a sensing method and an associated communication apparatus, a medium, and a chip.

### BACKGROUND

Radio frequency (RF) sensing technology is one of electromagnetic wave sensing technologies. Due to its penetrability and security, the radio frequency sensing technology can be used as an important alternative technology in security check, hidden object detection, environment reconstruction and monitoring, and the like. In addition, its good compatibility with a communication architecture facilitates normalized design with the communication architecture, another IoT device, or the like. For example, the radio frequency sensing technology may include a radar technology. Electromagnetic energy is transmitted into space using the radar technology. A direction, a height, and a speed of an object can be calculated and a shape of the object can be detected by receiving an electromagnetic wave reflected by the object in the space.

### SUMMARY

Example embodiments of this specification provide a solution for privacy protection in sensing.

According to a first aspect of this specification, a method for sensing a target object is provided. The method includes: A terminal device sends a first signal in response to the terminal device discovering the target object. The first signal is used to authenticate that the terminal device senses the target object. The method further includes: The terminal device receives a second signal. The second signal indicates sensing permission information of the target object. The method further includes: The terminal device determines, based on the sensing permission information, whether the terminal device is authenticated to sense the target object. The method further includes: The terminal device senses the target object if the terminal device is authenticated to sense the target object. In this way, authentication permission is implemented before the terminal device performs sensing, thereby improving privacy protection.

In some embodiments, the first signal is an excitation signal. That a terminal device sends a first signal includes: The terminal device sends the excitation signal to a first communication apparatus included in the target object. In this way, authentication on sensing permission is triggered, thereby improving privacy protection.

In some embodiments, that a terminal device sends a first signal includes: The terminal device sends the first signal to a second communication apparatus. The first signal is used to request the second communication apparatus to send an excitation signal to a first communication apparatus included in the target object. The second communication apparatus and the first communication apparatus are at different locations. The method further includes: The terminal device receives a third signal acknowledging the request from the second communication apparatus. In this way, another device is introduced to implement authentication on sensing permission and expand a scope of a sensible area.

In some embodiments, that the terminal device receives a second signal includes: The terminal device receives the second signal from the first communication apparatus. The second signal is a feedback signal of the first communication apparatus for the excitation signal, and the feedback signal includes sensing permission information of the target. In this way, authentication on sensing permission is implemented, thereby improving privacy protection.

In some embodiments, that the terminal device receives a second signal includes: The terminal device receives the second signal from the second communication apparatus. The second signal is a feedback signal of the first communication apparatus for the excitation signal. In this way, another device is introduced to implement authentication on sensing permission and expand a scope of a sensible area.

In some embodiments, the method further includes: The terminal device sends, to the second communication apparatus, a stop signal used to indicate the second communication apparatus to stop sending the excitation signal. In this way, control of an authentication process is implemented.

In some embodiments, a difference between a sending angle of the excitation signal for the first communication apparatus and a receiving angle of a reflected signal for a sensing signal used to sense the target object is less than a predetermined value. In this way, it is ensured that matching of the target object is implemented in an authentication process and in a sensing process, thereby improving privacy protection.

In some embodiments, the excitation signal is periodically sent or continuously sent during a period when the terminal device is authenticated to sense the target object and during a period when the terminal device senses the target object. In this way, it is ensured that matching of the target object is implemented in an authentication process and in a sensing process, thereby improving privacy protection.

In some embodiments, the method further includes: The terminal device sends the sensing signal to the first communication apparatus. In some embodiments, the method includes: The terminal device sends, to the second communication apparatus, an indication signal used to indicate the second communication apparatus to send the sensing signal to the first communication apparatus. In this way, sensing of the target object is implemented.

In some embodiments, the method further includes: The terminal device receives, from the first communication apparatus, a feedback signal of the first communication apparatus for the sensing signal. In some embodiments, the method further includes: The terminal device receives, from the second communication apparatus, a feedback signal of the first communication apparatus for the third signal; or the terminal device receives a feedback signal that is processed by the second communication apparatus and is for the third signal. In this way, sensing of the target object is implemented.

According to a second aspect of this specification, a method for sensing a target object is provided. The method includes: A first communication apparatus included in the target object receives an excitation signal. The excitation signal is used to excite the first communication apparatus to send sensing permission information of the target object, to complete authentication of a terminal device on sensing permission of the target object. The method further includes: The first communication apparatus sends a first feedback signal for the excitation signal. The first feedback signal indicates the sensing permission information of the target object. The method further includes: The first communication apparatus receives a sensing signal. The first communication apparatus reflects the sensing signal. In this way, authentication permission is implemented before the terminal device performs sensing, thereby improving privacy protection.

In some embodiments, the method further includes: The first communication apparatus broadcasts the first feedback signal. In this way, sending of authentication information is implemented.

In some embodiments, the method further includes: The first communication apparatus receives the excitation signal from the terminal device. In some embodiments, the method further includes: The first communication apparatus receives the excitation signal from a second communication apparatus. The second communication apparatus and the first communication apparatus are at different locations. In some embodiments, the method further includes: The first communication apparatus sends the first feedback signal to the terminal device. In some embodiments, the method further includes: The first communication apparatus sends the first feedback signal to the second communication apparatus. In this way, authentication permission is implemented before the terminal device performs sensing.

In some embodiments, the method further includes: The first communication apparatus receives the sensing signal from the terminal device. In some embodiments, the method further includes: The first communication apparatus receives the sensing signal from the second communication apparatus. In some embodiments, the method further includes: The first communication apparatus sends the sensing signal to the terminal device. In some embodiments, the method further includes: The first communication apparatus sends the sensing signal to the second communication apparatus. In this way, another device is introduced to implement authentication on sensing permission and expand a scope of a sensible area.

In some embodiments, the excitation signal is periodically sent or continuously received during a period when the terminal device senses the target object. In this way, it is ensured that matching of the target object is implemented in an authentication process and in a sensing process, thereby improving privacy protection.

According to a third aspect of this specification, a method for sensing a target object is provided. The method includes: A second communication apparatus receives a request signal from a terminal device. The request signal is used to request the second communication apparatus to send an excitation signal to a first communication apparatus included in the target object. The method includes: The second communication apparatus sends an acknowledgment signal for the request signal to the terminal device. The method includes: The second communication apparatus sends the excitation signal to the first communication apparatus. In this way, authentication permission is implemented before the terminal device performs sensing, thereby improving privacy protection.

In some embodiments, the method further includes: The second communication apparatus sends a sensing signal to the first communication apparatus. The method includes: The second communication apparatus receives a reflected signal of the sensing signal from the first communication apparatus. In this way, another device is introduced to implement authentication on sensing permission and expand a scope of a sensible area.

In some embodiments, a feedback signal is a broadcast signal. In this way, timely sending of authentication information is implemented. In some embodiments, the second communication apparatus forwards the reflected signal to the terminal device. In some embodiments, the method further includes: The second communication apparatus processes the reflected signal. The method further includes: The second communication apparatus sends the processed reflected signal to the terminal device. In this way, another device is introduced to implement authentication on sensing permission and expand a scope of a sensible area.

In some embodiments, a difference between a sending angle of the excitation signal for the first communication apparatus and a receiving angle of the reflected signal for the sensing signal used to sense the target object is less than a predetermined value. In this way, it is ensured that matching of the target object is implemented in an authentication process and in a sensing process, thereby improving privacy protection.

In some embodiments, the excitation signal is periodically sent or continuously sent during a period when the terminal device is authenticated to sense the target object and during a period when the terminal device senses the target object. In this way, it is ensured that matching of the target object is implemented in an authentication process and in a sensing process, thereby improving privacy protection.

According to a fourth aspect of this specification, a chip is provided. The chip is configured to perform operations of the method according to any one of the possible implementations of the first aspect.

According to a fifth aspect of this specification, a chip is provided. The chip is configured to perform operations of the method according to any one of the possible implementations of the second aspect.

According to a sixth aspect of this specification, a chip is provided. The chip is configured to perform operations of the method according to any one of the possible implementations of the third aspect.

According to a seventh aspect of this specification, a terminal device is provided. The terminal device includes at least one processing unit and at least one memory. The at least one memory is coupled to the at least one processing unit and stores instructions for execution by the at least one processing unit. When the instructions are executed by the at least one processing unit, the terminal device is enabled to implement the method according to any one of the possible implementations of the first aspect.

According to an eighth aspect of this specification, a communication apparatus is provided. The communication apparatus includes at least one processing unit and at least one memory. The at least one memory is coupled to the at least one processing unit and stores instruction for execution by the at least one processing unit. When the instructions are executed by the at least one processing unit, the communication apparatus is enabled to implement the method according to any one of the possible implementations of the second aspect.

According to a ninth aspect of this specification, a communication apparatus is provided. The communication apparatus includes at least one processing unit and at least one memory. The at least one memory is coupled to the at least one processing unit and stores instructions for execution by the at least one processing unit. When the instructions are executed by the at least one processing unit, the communication apparatus is enabled to implement the method according to any one of the possible implementations of the third aspect.

According to a tenth aspect of this specification, a computer program product is provided. The computer program product is tangibly stored on a computer-readable medium and includes computer executable instructions. When the computer executable instructions are executed, a device is enabled to implement operations in the method according to any one of the possible implementations of the first aspect, the second aspect, or the third aspect.

According to an eleventh aspect of this specification, a communication apparatus is provided. The communication apparatus includes a component configured to implement the method according to any one of the possible implementations of the first aspect.

According to a twelfth aspect of this specification, a communication apparatus is provided. The communication apparatus includes a component configured to implement the method according to any one of the possible implementations of the second aspect.

According to a thirteenth aspect of this specification, a communication apparatus is provided. The communication apparatus includes a component configured to implement the method according to any one of the possible implementations of the third aspect.

According to a fourteenth aspect of this specification, a communication system is provided. The communication system includes a component configured to implement the method according to any one of the possible implementations of the first aspect, a component configured to implement the method according to any one of the possible implementations of the second aspect, and a component configured to implement the method according to any one of the possible implementations of the third aspect.

### BRIEF DESCRIPTION OF DRAWINGS

Features, advantages, and other aspects of various implementations of this specification become more apparent with reference to the accompanying drawings and with reference to the following detailed descriptions. Several implementations of this specification are shown herein by way of example rather than a limitation. In the accompanying drawings:

FIG. 1A and FIG. 1B are respectively schematic block diagrams of a communication environment in which an embodiment of this specification may be implemented;

FIG. 2 is a flowchart implemented at a terminal device according to some embodiments of this specification;

FIG. 3 is a flowchart implemented at a communication apparatus according to some embodiments of this specification;

FIG. 4 is a flowchart implemented at a communication apparatus according to some other embodiments of this specification;

FIG. 5 is a signaling diagram of interaction in a communication process according to some embodiments of this specification;

FIG. 6 is a signaling diagram of interaction in a communication process according to some embodiments of this specification;

FIG. 7 is a signaling diagram of interaction in a communication process according to some embodiments of this specification;

FIG. 8A to FIG. 8C are respectively schematic block diagrams of a communication apparatus according to some embodiments of this specification; and

FIG. 9 is a simplified block diagram of an example device suitable for implementing an embodiment of this specification.

In each drawing, same or similar reference numerals represent same or similar elements.

### DESCRIPTION OF EMBODIMENTS

Embodiments of this specification are described in more detail in the following with reference to the accompanying drawings. Although some embodiments of this specification are shown in the accompanying drawings, it should be understood that this specification can be implemented in various forms, and should not be construed as being limited to embodiments described herein. On the contrary, these embodiments are provided for a more thorough and complete understanding of this specification. It should be understood that the accompanying drawings and embodiments of this specification are merely used as examples and are not intended to limit the protection scope of this specification.

In descriptions of embodiments of this specification, the term “including” and similar terms thereof should be understood as non-exclusive inclusion, that is, “including but not limited to”. The term “based on” should be understood as “at least partially based on”. The term “one embodiment” or “this embodiment” should be understood as “at least one embodiment”. In embodiments of this disclosure, for a technical feature, “first”, “second”, “third”, “A”, “B”, “C”, “D”, and the like are used for distinguishing between technical features in the technical feature. There is no chronological order or size order between the technical features described by “first”, “second”, “third”, “A”, “B”, “C”, and “D”. Other explicit and implicit definitions may also be included below.

The term “network device” used in this specification is an entity or a node that may be configured to communicate with a terminal device. The network device in embodiments of this disclosure includes an access network device, for example, a base station (BS). The BS may be a device that is deployed in a radio access network and that can perform wireless communication with a terminal. The base station may be in a plurality of forms such as a macro base station, a micro base station, a relay station, and an access point. For example, the base station in embodiments of this disclosure may be a base station in 5G or a base station in LTE. The base station in 5G may also be referred to as a transmission reception point (TRP) or a gNB. In embodiments of this disclosure, an apparatus configured to implement a function of a network device may be a network device, or may be an apparatus that can support the network device in implementing the function, for example, a chip system. The apparatus may be installed in the network device. In the technical solutions provided in embodiments of this disclosure, the technical solutions provided in embodiments of this disclosure are described by using an example in which the apparatus for implementing the function of the network device is a network device and the network device is a base station.

The technical solutions provided in embodiments of this disclosure may be applied to wireless communication between communication devices. The wireless communication between the communication devices may include: wireless communication between a network device and a terminal, wireless communication between network devices, and wireless communication between terminals. In embodiments of this disclosure, the term “wireless communication” may also be briefly referred to as “communication”, and the term “communication” may also be described as “data transmission”, “information transmission”, or “transmission”.

As described above, the radio frequency sensing technology can be used as an important alternative technology in security check, hidden object detection, environment reconstruction and monitoring, and the like. However, when the radio frequency sensing technology is used to detect an object, privacy protection of a to-be-measured object is not considered. These lead to some unexpected results, for example, information leakage of the to-be-measured object. Therefore, a new technical solution needs to be proposed to implement sensing and privacy protection of the to-be-measured object.

According to embodiments of this specification, a terminal device first authenticates whether the terminal device has permission to sense a to-be-measured object. If the terminal device has sensing permission, the terminal device senses the to-be-measured object. If the terminal device has no sensing permission, the terminal device does not sense the to-be-measured object. In this way, privacy leakage of the to-be-measured object is prevented.

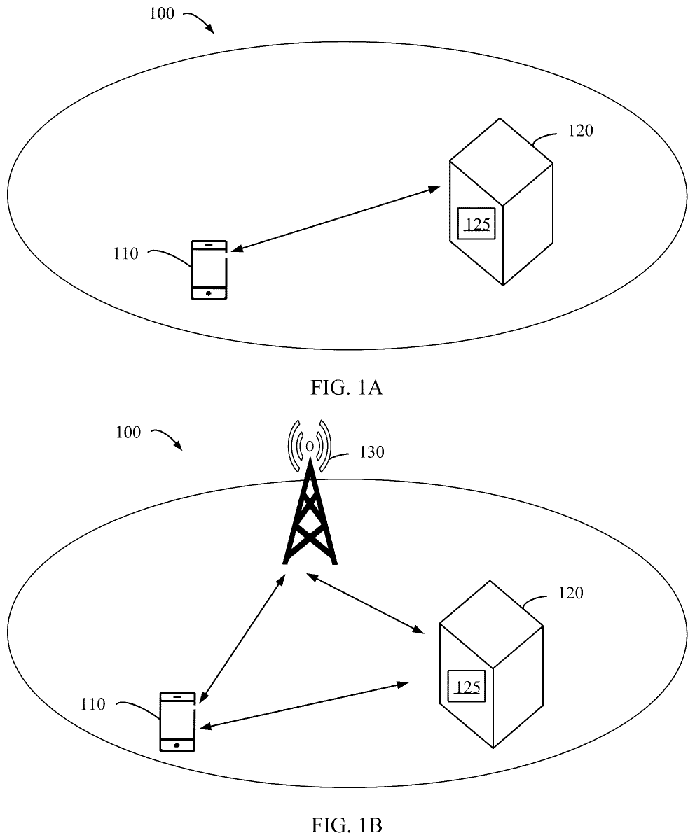

FIG. 1A and FIG. 1B are respectively schematic diagrams of a communication environment 100 in which an embodiment of this specification may be implemented. In some embodiments, as shown in FIG. 1A, the communication environment 100 may include a terminal device 110 and a target object 120 including a communication apparatus 125. Optionally, in another embodiment, as shown in FIG. 1B, the communication environment 100 may include a terminal device 110, a target object 120 including a communication apparatus 125, and a communication apparatus 130. The terminal device 110, the communication apparatus 125, and the communication apparatus 130 may communicate with each other. It should be understood that the numbers of devices shown in FIG. 1A and FIG. 1B and connections between the devices are given for a purpose of illustration, and are not limited. The communication environment 100 may include any suitable quantity of devices and networks suitable for implementing embodiments of this specification.

The terminal device 110 is any of terminal devices capable of wired or wireless communication with a network device or between each other. The terminal device in embodiments of this disclosure may also be referred to as a terminal, and may be a device having a wireless transceiver function. The terminal device may be deployed on land, including indoor or outdoor, handheld, or in-vehicle deployment; may be deployed on water (for example, on a steamship); or may be deployed in the air (for example, on an airplane, a balloon, and a satellite). The terminal device may be a user equipment (UE). The UE includes a handheld device, a vehicle-mounted device, a wearable device, or a computing device that has a wireless communication function. For example, the UE may be a mobile phone, a tablet computer, or a computer having a wireless transceiver function. The terminal device may alternatively be a virtual reality (VR) terminal device, an augmented reality (AR) terminal device, a wireless terminal in industrial control, a wireless terminal in self driving, a wireless terminal in telemedicine, a wireless terminal in a smart grid, a wireless terminal in a smart city, a wireless terminal in a smart home, or the like. In embodiments of this disclosure, an apparatus configured to implement a function of a terminal may be a terminal; or may be an apparatus that can support the terminal in implementing the function, for example, a chip system. The apparatus may be installed in the terminal. In embodiments of this disclosure, the chip system may include a chip, or may include a chip and another discrete component. In the technical solutions provided in embodiments of this disclosure, the technical solutions provided in embodiments of this disclosure are described by using an example in which the apparatus for implementing the function of the terminal is a terminal and the terminal is a UE.

The communication apparatus 125 may be a device that can perform contactless data communication. The communication apparatus 125 may be an apparatus having a radio frequency identification (RFID) function. For example, the communication apparatus 125 may be an RFID tag. The communication apparatus 125 may be one of an active RFID tag, a passive RFID tag, and a semi-active RFID tag. In some embodiments, the communication apparatus 125 may be an apparatus having an internet of things (IoT) function. For example, the communication apparatus 125 may be an IoT tag.

The communication apparatus 130 may be any suitable device that can assist in communication between the terminal device 110 and the communication apparatus 125. For example, the communication apparatus 130 may be any one of a base station, a gateway, or a Wi-Fi apparatus. The communication apparatus 130 may alternatively be a terminal device. The communication apparatus 130 may be referred to as an auxiliary device (Helper).

Communication in the communication environment 100 may be implemented according to any appropriate communication protocol. Embodiments of this specification may be implemented according to any appropriate communication protocol, including but not limited to cellular communication protocols such as the fourth generation (4G) and the fifth generation (5G), wireless local area network communication protocols such as the Institute of Electrical and Electronics Engineers (IEEE) 802.11, and/or any other protocol currently known or developed in the future. The technical solutions in embodiments of this specification are applied to any appropriate communication system, for example, a general packet radio system (GPRS), a long term evolution (LTE) system, a frequency division duplex (FDD) system, a time division duplex (TDD) system, a universal mobile telecommunication system (UMTS), a narrowband internet of things (NB-IoT) communication system, a fifth generation (5G) system or a new radio (NR) system, or a future communication system. Communication in the communication environment 100 may also be performed by using a radio frequency signal.

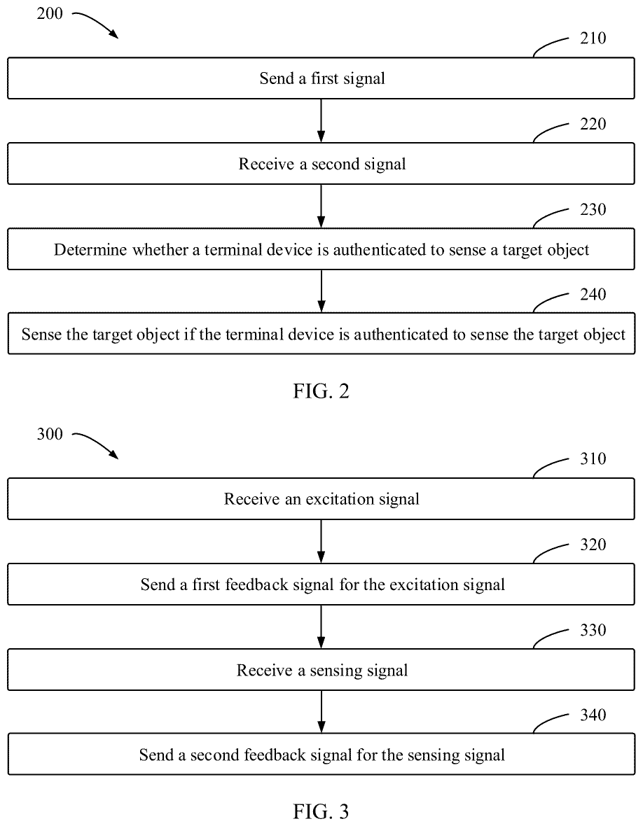

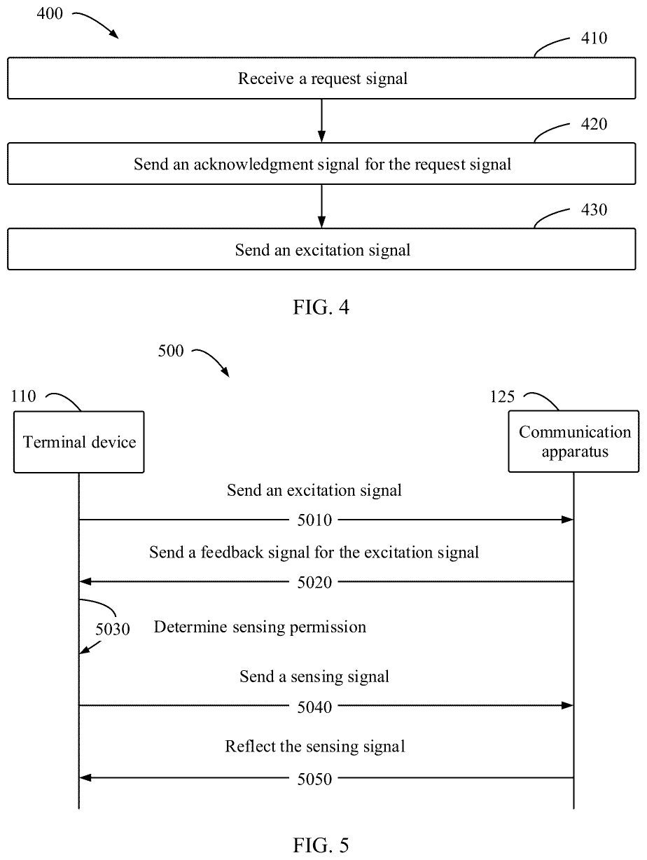

In example embodiments of this specification, for ease of discussion, procedures of privacy protection in sensing and signaling interaction between communication entities according to the example embodiments of this specification are described with reference to the example communication environment in FIG. 1A and FIG. 1B. It should be understood that the example embodiments of this specification may be applied to various scenarios. For example, embodiments of this specification may be applied to detection of transport articles, for example, express package and urban freight. Embodiments of this specification may be further applied to security detection in a public place, for example, detection in an airport, a subway, and a high-speed railway expressway. In addition, embodiments of this specification may be applied to bulk cargo detection, for example, cargo detection without unpacking at a freight terminal. The following briefly describes embodiments of this specification with reference to FIG. 2, FIG. 3, and FIG. 4.

FIG. 2 is a schematic flowchart of an example of a method 200 for sensing a target object. The method 200 is implemented at a terminal device, for example, a terminal device 110.

At step 210, the terminal device 110 sends a first signal. The first signal is used to authenticate that the terminal device senses the target object. In some embodiments, the terminal device 110 may send the first signal to a communication apparatus 125. In this case, the first signal is an excitation signal. In another embodiment, the terminal device 110 may send the first signal to a communication apparatus 130. In this case, the first signal is used to request the communication apparatus 130 to send the excitation signal. In some embodiments, the excitation signal may be a sequence. For example, the excitation signal may be an m-sequence. Optionally, the excitation signal may alternatively be a pseudo-random (PN) sequence. In some embodiments, after the terminal device 110 completes an authentication process, the excitation signal may also continue to be sent, thereby ensuring authentication accuracy.

At step 220, the terminal device 110 receives a second signal. The second signal indicates sensing permission information of the target object 120. In some embodiments, the second signal may be from the communication apparatus 125. In another embodiment, the terminal device 110 may receive the second signal from the communication apparatus 130. In this case, the second signal is a feedback signal for the excitation signal sent by the communication apparatus 130. The feedback signal includes the sensing permission information. The sensing permission information may include classification of levels for different detected user groups, and whether to grant sensing permission for a specific level. For example, if the target object 120 is a general article, the sensing permission information may indicate that authentication for detection is granted to all terminal devices. If the target object 120 is a special article (for example, a valuable article), the sensing permission information may indicate that authentication for sensing is granted to only one or some user equipment. In some embodiments, after the terminal device 110 completes the authentication process, the terminal device 110 may also continuously receive the feedback signal for the excitation signal from the communication apparatus 125, thereby ensuring authentication accuracy.

At step 230, the terminal device 110 determines, based on the sensing permission information, whether the terminal device 110 is authenticated to sense the target object 120. As a mere example, if the sensing permission information indicates that sensing permission is granted to one or more terminal devices, the terminal device 110 may determine whether the terminal device 110 belongs to these terminal devices. If the sensing permission information may indicate that authentication for detection is granted to all terminal devices, the terminal device 110 may determine that the terminal device 110 is authenticated to sense the target object 120.

At step 240, if the terminal device 110 is authenticated to sense the target object 120, the terminal device 110 senses the target object 120. In some embodiments, the terminal device 110 may send a sensing signal to the communication apparatus 125. In this case, the terminal device 110 may receive a reflected signal of the sensing signal from the communication apparatus 125, and sense the target object 120 based on the reflected signal. In another embodiment, the terminal device 110 may trigger the communication apparatus 130 to send the sensing signal to the communication apparatus 125. In this case, the terminal device 110 may receive, from the communication apparatus 130, the reflected signal of the sensing signal received by the communication apparatus 125.

In some embodiments, the sensing signal may be a sensing-oriented linear frequency-modulated continuous wave (FMCW) signal. For example, the terminal device 110 may send a continuous wave signal whose frequency linearly increases with time. In this case, when the sensing signal is reflected by the target object 120, due to a delay on a propagation path, there is a frequency difference Δf between the reflected signal and the sensing signal, and the frequency difference is positively correlated with a propagation delay. The terminal device 110 may perform frequency mixing on the received reflected signal and the sent sensing signal, to obtain the frequency difference Δf between the two. Further, the terminal device 110 may determine a distance between the terminal device 110 and the target object 120 based on the frequency difference. The terminal device 110 may further determine a reflection coefficient of the target object 120 based on energy of the reflected signal, to determine an inherent attribute of the target object 120.

Alternatively, the sensing signal may be a communication-oriented signal, for example, an OFDM signal. In this case, the terminal device 110 may determine a distance between the terminal device 110 and the target object 120 based on a delay between the sensing signal and the reflected signal. The terminal device 110 may alternatively determine a reflection coefficient of the target object 120 based on energy of the reflected signal, to determine an inherent attribute of the target object 120.

In some embodiments, the sensing signal and the excitation signal need to be sent at a same angle or in a same direction. For example, a difference between a sending angle of the sensing signal and a sending angle of the excitation signal is less than a predetermined value. In this way, privacy protection is further enhanced.

FIG. 3 is a schematic flowchart of an example of a method 300 for sensing a target object. The method 300 is implemented at a terminal device, for example, a communication apparatus 125.

At step 310, the communication apparatus 125 receives an excitation signal. The excitation signal is used to authenticate that a terminal device 110 senses the target object 120. In some embodiments, the communication apparatus 125 may receive the excitation signal from the terminal device 110. In another embodiment, the communication apparatus 125 may receive the excitation signal from a communication apparatus 130. As described above, the excitation signal may be a sequence. For example, the excitation signal may be an M-sequence or a PN sequence. In some embodiments, after the terminal device 110 completes an authentication process, the communication apparatus 125 may also continuously receive the excitation signal, thereby ensuring authentication accuracy.

At step 320, the communication apparatus 125 sends a first feedback signal for the excitation signal. The first feedback signal indicates sensing permission information of the target object 120. In some embodiments, the communication apparatus 125 may send the first feedback signal to the terminal device 110. In another embodiment, the communication apparatus 125 may send the first feedback signal to the communication apparatus 130. In some embodiments, the first feedback signal may be an omnidirectional signal. Alternatively, the first feedback signal may be a directional signal. The sensing permission information may include classification of levels for different detected user groups, and whether to grant sensing permission for a specific level.

At step 330, the communication apparatus 125 receives a sensing signal. In some embodiments, the communication apparatus 125 may receive the sensing signal from the terminal device 110. In another embodiment, the communication apparatus 125 may receive the sensing signal from the communication apparatus 130. In some embodiments, the sensing signal may be a sensing-oriented FMCW signal. Alternatively, the sensing signal may be a communication-oriented signal.

At step 340, the communication apparatus 125 reflects the sensing signal. In some embodiments, the communication apparatus 125 may reflect the sensing signal to the terminal device 110. In another embodiment, the communication apparatus 125 may reflect the sensing signal to the communication apparatus 130. In some embodiments, the reflected signal may be an omnidirectional signal. Alternatively, the reflected signal may be a directional signal.

FIG. 4 is a schematic flowchart of an example of a method 400 for sensing a target object. The method 400 is implemented at a terminal device, for example, a communication apparatus 130.

At step 410, the communication apparatus 130 receives a request signal from a terminal device 110. The request signal is used to request the communication apparatus 130 to send an excitation signal to the target object 120. The request signal may be a signal of any appropriate communication protocol.

At step 420, the communication apparatus 130 sends an acknowledgment signal for the request signal to the terminal device 110. At block 430, the communication apparatus 130 sends the excitation signal to a communication apparatus 125. In some embodiments, the excitation signal may be a sequence. For example, the excitation signal may be an M-sequence or a PN sequence. In some embodiments, after the terminal device 110 completes an authentication process, the communication apparatus 130 may continuously send the excitation signal, to ensure authentication accuracy.

It may be understood that a sequence of blocks 420 and 430 shown in FIG. 4 is merely an example. In some embodiments, the communication apparatus 130 may first send the acknowledgment signal for the request signal, and then send the excitation signal. In another embodiment, the communication apparatus 130 may first send the excitation signal, and then send the acknowledgment signal for the request signal. In some embodiments, the communication apparatus 130 may simultaneously send the acknowledgment signal and the excitation signal for the request signal.

In some embodiments, the communication apparatus 130 may send a sensing signal to the communication apparatus 125. In some embodiments, the sensing signal may be a sensing-oriented FMCW signal. Optionally, the sensing signal may alternatively be a communication-oriented signal.

The communication apparatus 130 may further receive a reflected signal of the sensing signal from the communication apparatus 125. In some embodiments, the communication apparatus 130 may directly forward the received reflected signal to the terminal device 110. Alternatively, the communication apparatus 130 may process the received reflected signal, and send the processed reflected signal to the terminal device 110. In some embodiments, the reflected signal may be an omnidirectional signal. Alternatively, the reflected signal may be a directional signal.

It may be understood that the foregoing descriptions of the method 200, the method 300, and the method 400 are merely general descriptions of embodiments. The following describes specific example embodiments with reference to FIG. 5 to FIG. 7.

FIG. 5 is a signaling diagram of interaction 500 between devices in two-point networking including a terminal device and a target object. The interaction 500 is described below with reference to FIG. 1A. The interaction 500 includes two main parts, namely, an authentication process and a sensing process.

A terminal device 110 sends (5010) an excitation signal to a communication apparatus 125. In some embodiments, the terminal device 110 may send the excitation signal after determining existence of a target object 120. For example, the terminal device 110 may obtain existence information of the target object 120. The excitation signal is used to authenticate that the terminal device 110 senses the target object 120. The excitation signal may be a sequence signal. For example, the excitation signal may be a PN sequence. Optionally, the excitation signal may be an M-sequence. In some embodiments, the terminal device 110 may send the excitation signal by using communication data. For example, the terminal device 110 may include the excitation signal in an OFDM signal. Alternatively, the terminal device 110 may send the excitation signal by using a sensing signal. For example, the terminal device 110 may include the excitation signal in an FMCW signal. It may be understood that the excitation signal may be sent in any proper manner. In some embodiments, the excitation signal may be a directional signal. For example, the terminal device 110 may determine a direction of the target object 120 based on existence information of the target object 120, and then send the excitation signal. In another embodiment, the excitation signal may be an omnidirectional signal.

In some embodiments, the terminal device 110 may periodically send the excitation signal. A period for sending the excitation signal may be determined by the terminal device 110. Alternatively, the terminal device 110 may continuously send the excitation signal. In this way, privacy protection is further improved.

The communication apparatus 125 sends (5020) a feedback signal for the excitation signal to the terminal device 110. The feedback signal may be an omnidirectional signal. In other words, the communication apparatus 125 may broadcast the feedback signal. In some embodiments, the feedback signal may be a directional signal. For example, the communication apparatus 125 may send the feedback signal based on a direction of the excitation signal. In some embodiments, the feedback signal is a reflected signal for the excitation signal, and may also be referred to as an echo signal. In another embodiment, the feedback signal is sent by triggering the excitation signal.

The feedback signal indicates sensing permission information of the target object 120. The sensing permission information may include classification of levels for different detected user groups, and whether to grant sensing permission for a specific level. For example, if the target object 120 is a general article, the sensing permission information may indicate that authentication for detection is granted to all terminal devices. If the target object 120 is a special article (for example, a valuable article), the sensing permission information may indicate that authentication for sensing is granted to only one or some user equipment.

The terminal device 110 determines (5030), based on the sensing permission information, whether the terminal device 110 is authenticated to sense the target object 120. As a mere example, if the sensing permission information indicates that sensing permission is granted to one or more terminal devices, the terminal device 110 may determine whether the terminal device 110 belongs to these terminal devices. If the sensing permission information may indicate that authentication for detection is granted to all terminal devices, the terminal device 110 may determine that the terminal device 110 is authenticated to sense the target object 120. If the terminal device 110 is not authenticated to sense the target object 120, the terminal device 110 does not sense the target object 120.

If the terminal device 110 is authenticated to sense the target object 120, the terminal device 110 senses the target object 120. In this case, the terminal device 110 sends 5040 the sensing signal to the communication apparatus. In some embodiments, the sensing signal may be a sensing-oriented linear FMCW signal. For example, the terminal device 110 may send a continuous wave signal whose frequency linearly increases with time. Alternatively, the sensing signal may be a communication-oriented signal, for example, an OFDM signal.

The communication apparatus 125 sends (5050) the sensing signal to the terminal device 110. The reflected signal may be an omnidirectional signal. In other words, the communication apparatus 125 may broadcast the reflected signal. In some embodiments, the reflected signal may be a directional signal.

The terminal device 110 may determine information about the target object 120 based on the received reflected signal. For example, in some embodiments, as described above, the terminal device 110 may send a continuous wave signal whose frequency linearly increases with time. In this case, when the sensing signal is reflected by the target object 120, due to a delay on a propagation path, there is a frequency difference Δf between the reflected signal and the sensing signal, and the frequency difference is positively correlated with a propagation delay. The terminal device 110 may perform frequency mixing on the received reflected signal and the sent sensing signal, to obtain the frequency difference Δf between the two. Further, the terminal device 110 may determine a distance between the terminal device 110 and the target object 120 based on the frequency difference. The terminal device 110 may further determine a reflection coefficient of the target object 120 based on energy of the reflected signal, to determine an inherent attribute of the target object 120.

Alternatively, in some embodiments, as described above, the terminal device 110 may send an OFDM signal. In this case, the terminal device 110 may determine a distance between the terminal device 110 and the target object 120 based on a delay between the sensing signal and the reflected signal. The terminal device 110 may alternatively determine a reflection coefficient of the target object 120 based on energy of the reflected signal, to determine an inherent attribute of the target object 120.

In some embodiments, the terminal device 110 may keep sending the excitation signal while sensing the target object 120. In other words, in a process of sensing the target object 120, the authentication process of the terminal device 110 is not interrupted. This method further enhances privacy protection in a process of sensing a target, and avoids a problem that RFID authentication initiated by a user does not match the target.

If the terminal device 110 implements a target for sensing, the terminal device 110 may stop the sensing process. In this case, the terminal device 110 may stop sending the excitation signal and the sensing signal. In some embodiments, the terminal device 110 may sense the target object 120 in another direction. For example, the terminal device 110 may send the sensing signal again from another angle, to implement multi-angle sensing and detection of the target object 120.

In some embodiments, a sending angle of the sensing signal and a receiving angle of the feedback signal for the excitation signal need to be at a same angle or in a same direction. For example, a difference between the sending angle of the sensing signal and the receiving angle of the feedback signal for the excitation signal is less than a predetermined angle. In this way, it is ensured that an authenticated object and a sensed object are a same object.

According to the foregoing embodiment of this specification, through an RFID authentication process, permission to sense a target is added, thereby protecting privacy of a customer. At the same time, permission to sensing and detection is allocated to the customer, thereby facilitating inspection by a law enforcement agency. In addition, user privacy protection may be further enhanced by setting requirements for RFID authentication and target sensing signal detection. Further, in the foregoing embodiments, hardware does not need to be modified. In addition, the foregoing embodiments use characteristics of high-frequency sensing and detection to resolve a problem of user privacy protection by introducing characteristics of RFID.

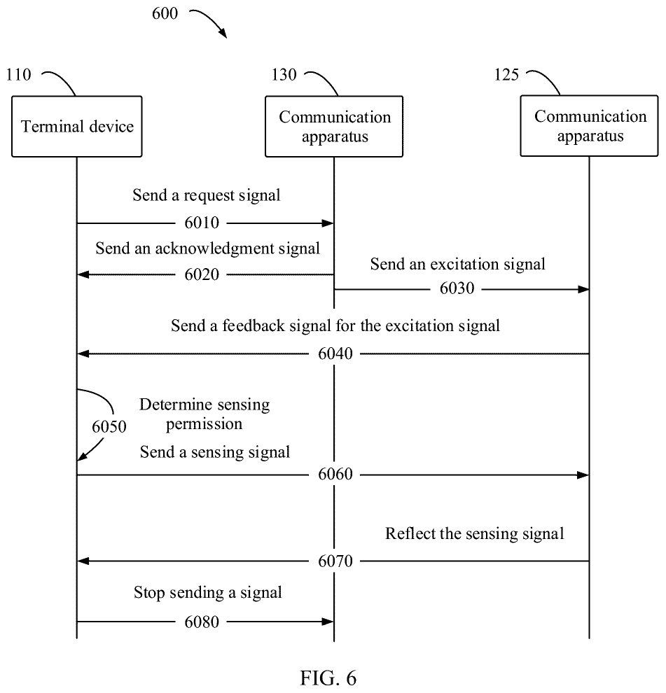

FIG. 6 shows a signaling diagram of interaction 600 between devices in three-point networking including a terminal device and a target object. The interaction 600 is described below with reference to FIG. 1B. The interaction 600 includes two main parts, namely, an authentication process and a sensing process. In some embodiments, a communication apparatus 130 may be determined by a terminal device 110. Optionally, the communication apparatus 130 may be determined by a network device. Turning on and off of the communication apparatus 130 may be triggered by the terminal device 110.

The terminal device 110 sends (6010) a request signal to the communication apparatus 130. In some embodiments, the terminal device 110 may send a request signal after determining existence of a target object 120. For example, the terminal device 110 may obtain existence information of the target object 120. The request signal is used to request the communication apparatus 130 to send an excitation signal to a communication apparatus 125. The request signal may be a signal of any appropriate communication protocol.

The communication apparatus 130 sends 6020 an acknowledgment signal for the request signal to the terminal device 110. The communication apparatus 130 may search for the target object 120. After finding the target object 120, the communication apparatus 130 sends 6030 the excitation signal to the communication apparatus 125. It may be understood that a sequence of sending the acknowledgment signal and the excitation signal shown in FIG. 6 is merely an example. In some embodiments, the communication apparatus 130 may first send the acknowledgment signal for the request signal, and then send the excitation signal. In another embodiment, the communication apparatus 130 may first send the excitation signal, and then send the acknowledgment signal for the request signal. In some embodiments, the communication apparatus 130 may simultaneously send the acknowledgment signal and the excitation signal for the request signal.

The excitation signal is used to authenticate that the terminal device 110 senses the target object 120. The excitation signal may be a sequence signal. For example, the excitation signal may be a PN sequence. Optionally, the excitation signal may be an M-sequence. In some embodiments, the communication apparatus 130 may send the excitation signal by using communication data. For example, the communication apparatus 130 may include the excitation signal in an OFDM signal. Optionally, the communication apparatus 130 may also send the excitation signal by using a sensing signal. For example, the communication apparatus 130 may include the excitation signal in an FMCW signal. It may be understood that the excitation signal may be sent in any proper manner. In some embodiments, the excitation signal may be a directional signal. In another embodiment, the excitation signal may be an omnidirectional signal. In some embodiments, after the terminal device 110 completes the authentication process, the communication apparatus 130 may continuously send the excitation signal, thereby further improving privacy protection.

The communication apparatus 125 sends (6040) a feedback signal for the excitation signal to the terminal device 110. The feedback signal may be an omnidirectional signal. In other words, the communication apparatus 125 may broadcast the feedback signal. In some embodiments, the feedback signal may be a directional signal. For example, the communication apparatus 125 may send the feedback signal based on a direction of the excitation signal. In some embodiments, the feedback signal is a reflected signal for the excitation signal, and may also be referred to as an echo signal. In another embodiment, the feedback signal is sent by triggering the excitation signal.

The feedback signal indicates sensing permission information of the target object 120. The sensing permission information may include classification of levels for different detected user groups, and whether to grant sensing permission for a specific level. For example, if the target object 120 is a general article, the sensing permission information may indicate that authentication for detection is granted to all terminal devices. If the target object 120 is a special article (for example, a valuable article), the sensing permission information may indicate that authentication for sensing is granted to only one or some user equipment.

The terminal device 110 determines (6050), based on the sensing permission information, whether the terminal device 110 is authenticated to sense the target object 120. As a mere example, if the sensing permission information indicates that sensing permission is granted to one or more terminal devices, the terminal device 110 may determine whether the terminal device 110 belongs to these terminal devices. If the sensing permission information may indicate that authentication for detection is granted to all terminal devices, the terminal device 110 may determine that the terminal device 110 is authenticated to sense the target object 120. If the terminal device 110 is not authenticated to sense the target object 120, the terminal device 110 does not sense the target object 120.

If the terminal device 110 is authenticated to sense the target object 120, the terminal device 110 senses the target object 120. In this case, the terminal device 110 sends (6060) the sensing signal to the communication apparatus 125. In some embodiments, the sensing signal may be a sensing-oriented linear FMCW signal. For example, the terminal device 110 may send a continuous wave signal whose frequency linearly increases with time. Alternatively, the sensing signal may be a communication-oriented signal, for example, an OFDM signal.

The communication apparatus 125 sends (6070) the sensing signal to the terminal device 110. The reflected signal may be an omnidirectional signal. In other words, the communication apparatus 125 may broadcast the reflected signal. In some embodiments, the reflected signal may be a directional signal.

The terminal device 110 may determine information about the target object 120 based on the received reflected signal. For example, in some embodiments, as described above, the terminal device 110 may send a continuous wave signal whose frequency linearly increases with time. In this case, when the sensing signal is reflected by the target object 120, due to a delay on a propagation path, there is a frequency difference Δf between the reflected signal and the sensing signal, and the frequency difference is positively correlated with a propagation delay. The terminal device 110 may perform frequency mixing on the received reflected signal and the sent sensing signal, to obtain the frequency difference Δf between the two. Further, the terminal device 110 may determine a distance between the terminal device 110 and the target object 120 based on the frequency difference. The terminal device 110 may further determine a reflection coefficient of the target object 120 based on energy of the reflected signal, to determine an inherent attribute of the target object 120.

Alternatively, in some embodiments, as described above, the terminal device 110 may send an OFDM signal. In this case, the terminal device 110 may determine a distance between the terminal device 110 and the target object 120 based on a delay between the sensing signal and the reflected signal. The terminal device 110 may alternatively determine a reflection coefficient of the target object 120 based on energy of the reflected signal, to determine an inherent attribute of the target object 120.

If the terminal device 110 implements sensing a target, the terminal device 110 may stop the sensing process. In this case, the terminal device 110 may send 6080 a stop signal to the communication apparatus 130, so that the communication apparatus 130 stops sending the excitation signal to the communication apparatus 125. In some embodiments, the terminal device 110 may sense the target object 120 in another direction. For example, the terminal device 110 may send the sensing signal again from another angle, to implement multi-angle sensing and detection of the target object 120.

In some embodiments, a sending angle of the sensing signal and a receiving angle of the feedback signal for the excitation signal need to be at a same angle or in a same direction. For example, a difference between the sending angle of the sensing signal and the receiving angle of the feedback signal for the excitation signal is less than a predetermined angle. In this way, it is ensured that an authenticated object and a sensed object are a same object.

According to the foregoing embodiment of this specification, through an RFID authentication process, permission to sense a target is added, thereby protecting privacy of a customer. At the same time, permission to sensing and detection is allocated to the customer, thereby facilitating inspection by a law enforcement agency. In addition, user privacy protection may be further enhanced by setting requirements for RFID authentication and target sensing signal detection. Further, in the foregoing embodiments, hardware does not need to be modified. In addition, the foregoing embodiments use characteristics of high-frequency sensing and detection to resolve a problem of user privacy protection by introducing characteristics of RFID. Through introduction of the communication apparatus 130, a demand for short-distance excitation of an IoT device is addressed, and a scenario of long-distance sensing and detection can be met. According to the foregoing embodiments of this specification, hardware does not need to be modified. In addition, the foregoing embodiments use characteristics of high-frequency sensing and detection resolve a problem of user privacy protection by introducing characteristics of RFID. Characteristics of high-frequency detection include strong penetration and narrow beams.

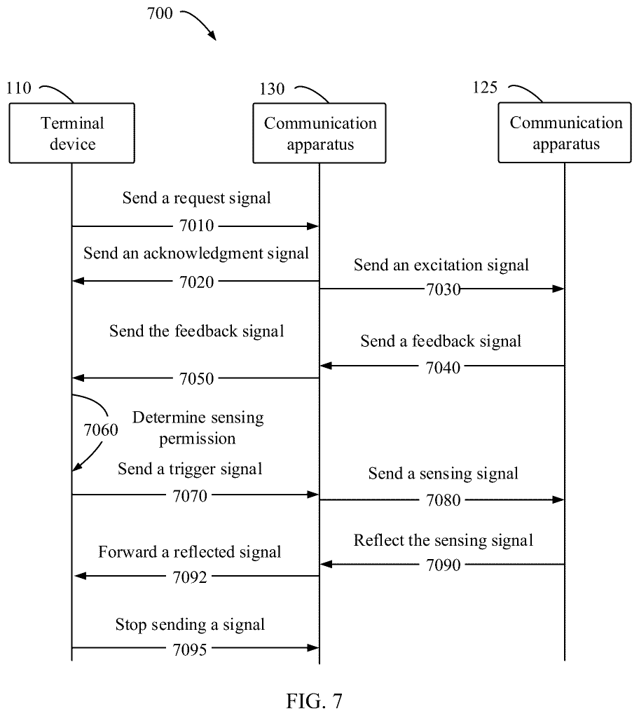

FIG. 7 shows a signaling diagram of interaction 700 between devices in three-point networking including a terminal device and a target object. The interaction 700 is described below with reference to FIG. 1B. The interaction 700 includes two main parts, namely, an authentication process and a sensing process. In some embodiments, a communication apparatus 130 may be determined by a terminal device 110. Optionally, the communication apparatus 130 may be determined by a network device. Turning on and off of the communication apparatus 130 may be triggered by the terminal device 110.

The terminal device 110 sends 7010 a request signal to the communication apparatus 130. In some embodiments, the terminal device 110 may send a request signal after determining existence of a target object 120. For example, the terminal device 110 may obtain existence information of the target object 120. The request signal is used to request the communication apparatus 130 to send an excitation signal to a communication apparatus 125. The request signal may be a signal of any appropriate communication protocol.

The communication apparatus 130 sends 7020 an acknowledgment signal for the request signal to the terminal device 110. In some embodiments, if the communication apparatus 130 receives the request signal from a plurality of terminal devices, the communication apparatus 130 sends the acknowledgment signal to each of the terminal devices. In this case, the acknowledgment signal may indicate a sending time of the excitation signal triggered by the terminal device. In this way, different terminal devices are distinguished, thereby avoiding confusion in the authentication process.

The communication apparatus 130 may search for the target object 120. After finding the target object 120, the communication apparatus 130 sends 7030 the excitation signal to the communication apparatus 125. The excitation signal is used to authenticate that the terminal device 110 senses the target object 120. The excitation signal may be a sequence signal. For example, the excitation signal may be a PN sequence. Optionally, the excitation signal may be an m-sequence. In some embodiments, the communication apparatus 130 may send the excitation signal by using communication data. For example, the communication apparatus 130 may include the excitation signal in an OFDM signal. Optionally, the communication apparatus 130 may also send the excitation signal by using a sensing signal. For example, the communication apparatus 130 may include the excitation signal in an FMCW signal. It may be understood that the excitation signal may be sent in any proper manner. In some embodiments, the excitation signal may be a directional signal. In another embodiment, the excitation signal may be an omnidirectional signal. In some embodiments, after the terminal device 110 completes the authentication process, the communication apparatus 130 may continuously send the excitation signal in time domain, thereby further improving privacy protection.

It may be understood that a sequence of sending the acknowledgment signal and the excitation signal shown in FIG. 7 is merely an example. In some embodiments, the communication apparatus 130 may first send the acknowledgment signal for the request signal, and then send the excitation signal. In another embodiment, the communication apparatus 130 may first send the excitation signal, and then send the acknowledgment signal for the request signal. In some embodiments, the communication apparatus 130 may simultaneously send the acknowledgment signal and the excitation signal for the request signal.

The communication apparatus 125 sends 7040 a feedback signal for the excitation signal to the communication apparatus 130. The feedback signal may be an omnidirectional signal. In other words, the communication apparatus 125 may broadcast the feedback signal. In some embodiments, the feedback signal may be a directional signal. For example, the communication apparatus 125 may send the feedback signal based on a direction of the excitation signal. In some embodiments, the feedback signal is a reflected signal for the excitation signal, and may also be referred to as an echo signal. In another embodiment, the feedback signal is sent by triggering the excitation signal.

The feedback signal indicates sensing permission information of the target object 120. The sensing permission information may include classification of levels for different detected user groups, and whether to grant sensing permission for a specific level. For example, if the target object 120 is a general article, the sensing permission information may indicate that authentication for detection is granted to all terminal devices. If the target object 120 is a special article (for example, a valuable article), the sensing permission information may indicate that authentication for sensing is granted to only one or some user equipment.

The communication apparatus 130 sends 7050 the feedback signal to the terminal device 110. The terminal device 110 determines 7060, based on the sensing permission information, whether the terminal device 110 is authenticated to sense the target object 120. As a mere example, if the sensing permission information indicates that sensing permission is granted to one or more terminal devices, the terminal device 110 may determine whether the terminal device 110 belongs to these terminal devices. If the sensing permission information may indicate that authentication for detection is granted to all terminal devices, the terminal device 110 may determine that the terminal device 110 is authenticated to sense the target object 120. If the terminal device 110 is not authenticated to sense the target object 120, the terminal device 110 does not sense the target object 120.

If the terminal device 110 is authenticated to sense the target object 120, the terminal device 110 senses the target object 120. In this case, the terminal device 110 sends 7070 a trigger signal to the communication apparatus 130, and the trigger signal is used to trigger the communication apparatus 130 to send the sensing signal.

The communication apparatus 130 sends 7080 the sensing signal to the communication apparatus 125. In some embodiments, the sensing signal may be a sensing-oriented linear FMCW signal. For example, the communication apparatus 130 may send a continuous wave signal whose frequency linearly increases with time. Alternatively, the sensing signal may be a communication-oriented signal, for example, an OFDM signal.

The communication apparatus 125 reflects 7090 the sensing signal to the communication apparatus 130. The reflected signal may be an omnidirectional signal. In other words, the communication apparatus 125 may broadcast the reflected signal. In some embodiments, the reflected signal may be a directional signal.

The communication apparatus 130 forwards 7092 the received reflected signal to the terminal device 110. In some embodiments, the communication apparatus 130 may directly forward the received reflected signal to the terminal device 110. In this way, the sensing process can be completed more quickly. Alternatively, the communication apparatus 130 may process the received reflected signal, and send the processed reflected signal to the terminal device 110. In this way, a processing task at the terminal device can be reduced.

The terminal device 110 may determine information about the target object 120 based on the received reflected signal. For example, in some embodiments, as described above, the terminal device 110 may send a continuous wave signal whose frequency linearly increases with time. In this case, when the sensing signal is reflected by the target object 120, due to a delay on a propagation path, there is a frequency difference Δf between the reflected signal and the sensing signal, and the frequency difference is positively correlated with a propagation delay. The terminal device 110 may perform frequency mixing on the received reflected signal and the sent sensing signal, to obtain the frequency difference Δf between the two. Further, the terminal device 110 may determine a distance between the terminal device 110 and the target object 120 based on the frequency difference. The terminal device 110 may further determine a reflection coefficient of the target object 120 based on energy of the reflected signal, to determine an inherent attribute of the target object 120.

Alternatively, in some embodiments, as described above, the terminal device 110 may send an OFDM signal. In this case, the terminal device 110 may determine a distance between the terminal device 110 and the target object 120 based on a delay between the sensing signal and the reflected signal. The terminal device 110 may alternatively determine a reflection coefficient of the target object 120 based on energy of the reflected signal, to determine an inherent attribute of the target object 120.

If the terminal device 110 implements sensing a target, the terminal device 110 may stop the sensing process. In this case, the terminal device 110 may send 7095 a stop signal to the communication apparatus 130, so that the communication apparatus 130 stops sending the excitation signal to the communication apparatus 125. In some embodiments, the terminal device 110 may sense the target object 120 in another direction. For example, the terminal device 110 may trigger the communication apparatus 130 to send the sensing signal again from another angle, to implement multi-angle sensing and detection of the target object 120.

In some embodiments, a sending angle of the sensing signal and a receiving angle of the feedback signal for the excitation signal need to be at a same angle or in a same direction. For example, a difference between the sending angle of the sensing signal and the receiving angle of the feedback signal for the excitation signal is less than a predetermined angle. In this way, it is ensured that an authenticated object and a sensed object are a same object.

According to the foregoing embodiment of this specification, through an RFID authentication process, permission to sense a target is added, thereby protecting privacy of a customer. At the same time, permission to sensing and detection is allocated to the customer, thereby facilitating inspection by a law enforcement agency. In addition, user privacy protection may be further enhanced by setting requirements for RFID authentication and target sensing signal detection. Further, in the foregoing embodiments, hardware does not need to be modified. In addition, the foregoing embodiments use characteristics of high-frequency sensing and detection to resolve a problem of user privacy protection by introducing characteristics of RFID. Through introduction of the communication apparatus 130, a demand for short-distance excitation of an IoT device is addressed, and a scenario of long-distance sensing and detection can be met. According to the foregoing embodiments of this specification, hardware does not need to be modified. In addition, the foregoing embodiments use characteristics of high-frequency sensing and detection resolve a problem of user privacy protection by introducing characteristics of RFID.

Characteristics of high-frequency detection include strong penetration and narrow beams.

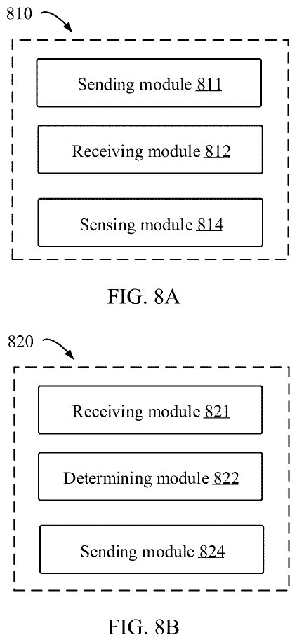

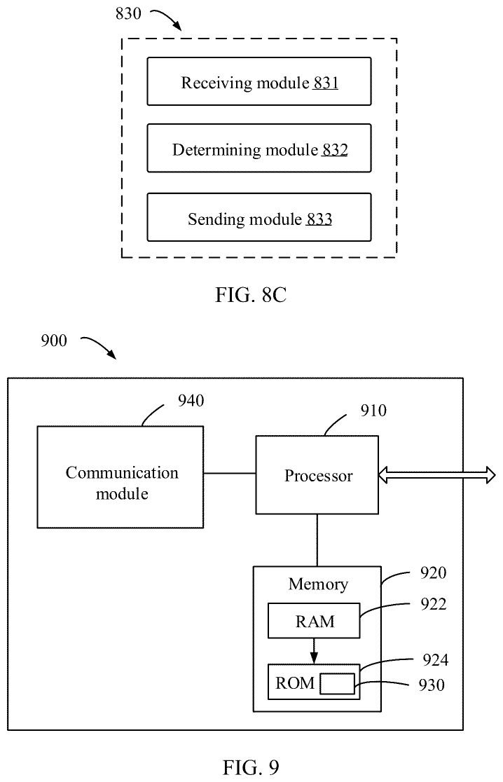

FIG. 8A is a schematic block diagram of an apparatus 810 for sensing an object according to some embodiments of this specification. The apparatus 810 may be implemented as a device or a chip in a device. The scope of this specification is not limited in this aspect. The apparatus 810 may be implemented as the terminal device 110 shown in FIG. 1A and FIG. 1B or a part of the terminal device 110. As shown in FIG. 8A, the apparatus 810 includes a sending module 811, configured to send a first signal. The first signal is used to authenticate that the terminal device senses a target object. For example, the sending module 811 may perform step S010 in FIG. 5, step 6010 in FIG. 6, or step 7010 in FIG. 7. The apparatus 810 further includes a receiving module 812, configured to receive a second signal. The second signal indicates sensing permission information of the target object. The apparatus 810 further includes a sensing module 814, configured to: determine, based on the sensing permission information, whether the terminal device is authenticated to sense the target object; and sense the target object. For example, the sensing module 814 may perform step S030 in FIG. 5, step 6050 in FIG. 6, or step 7060 in FIG. 7. The apparatus 810 may further include modules configured to implement steps performed by the terminal device 110 in FIG. 5 to FIG. 7. For brevity, details are not described herein again.

FIG. 8B is a schematic block diagram of an apparatus 820 for sensing an object according to some embodiments of this specification. The apparatus 820 may be implemented as a device or a chip in a device. The scope of this specification is not limited in this aspect. The apparatus 820 may be implemented as the communication apparatus 125 shown in FIG. 1A and FIG. 1B or a part of the communication apparatus 125. As shown in FIG. 8B, the apparatus 820 includes a receiving module 821, configured to receive an excitation signal. The excitation signal is used to authenticate that the terminal device senses a target object. The apparatus 820 includes a determining module 822, configured to determine a first feedback signal for the excitation signal. The first feedback signal indicates sensing permission information of the target object. The apparatus 820 includes a sending module 824, configured to send the first feedback signal for the excitation signal. The first feedback signal indicates the sensing permission information of the target object. For example, the sending module 824 may perform step S020 in FIG. 5, step 6040 in FIG. 6, or step 7040 in FIG. 7. The receiving module 821 is further configured to receive a sensing signal. The sending module 824 is further configured to reflect the sensing signal. For example, the sending module 824 may perform step S050 in FIG. 5, step 6070 in FIG. 6, or step 7090 in FIG. 7. The apparatus 820 may further include modules configured to implement steps performed by the communication apparatus 125 in FIG. 5 to FIG. 7. For brevity, details are not described herein again.

FIG. 8C is a schematic block diagram of an apparatus 830 for sensing an object according to some embodiments of this specification. The apparatus 830 may be implemented as a device or a chip in a device. The scope of this specification is not limited in this aspect. The apparatus 830 may be implemented as the communication apparatus 130 shown in FIG. 1B or a part of the communication apparatus 130. As shown in FIG. 8C, the apparatus 830 includes a receiving module 831, configured to receive a request signal. The request signal is used to request a second communication apparatus to send an excitation signal to a first communication apparatus included in a target object. The apparatus 830 includes a determining module 832, configured to determine an acknowledgment signal for the request signal. The apparatus 830 includes: a sending module 833, configured to send the acknowledgment signal for the request signal. For example, the sending module 833 may perform step 6020 in FIG. 6 or step 7020 in FIG. 7. The sending module 833 is further configured to send the excitation signal. For example, the sending module 833 may perform step 8030 in FIG. 6 or step 7030 in FIG. 7. The apparatus 830 may further include modules configured to implement steps performed by the communication apparatus 130 in FIG. 6 and FIG. 7. For brevity, details are not described herein again.

FIG. 9 is a simplified block diagram of an example device 900 suitable for implementing an embodiment of this specification. The device 900 may be configured to implement the terminal device or the network device shown in FIG. 1A and FIG. 1B. As shown in the figure, the device 900 includes one or more processors 910, one or more memories 920 coupled to the processor 910, and a communication module 940 coupled to the processor 910. In some embodiments, the memory 920 and the processor 910 may be integrated together.

The communication module 940 may be configured for bidirectional communication. The communication module 940 may have at least one communication interface for communication. The communication interface may include any interface necessary for communicating with another device.

The processor 910 may be of any appropriate type of a local technology network, and may include but is not limited to at least one of the following: a general-purpose computer, a dedicated computer, a microcontroller, a digital signal processor (DSP), or a controller-based multi-core controller architecture. The device 900 may have a plurality of processors, such as an application-specific integrated circuit chip, which in time belongs to a clock synchronized with a main processor.

The memory 920 may include one or more non-volatile memories and one or more volatile memories. Examples of the non-volatile memory include but are not limited to at least one of the following: a read-only memory (ROM) 924, an erasable programmable read only memory (EPROM), a flash memory, a hard disk, a compact disc (CD), a digital versatile disc (DVD), or another magnetic storage device and/or an optical storage device. Examples of the volatile memory include but are not limited to at least one of the following: a random access memory (RAM) 922, or another volatile memory that does not persist for duration of a power failure.

A computer program 930 includes computer-executable instructions performed by an associated processor 910. The program 930 may be stored in the ROM 924. The processor 910 may perform any suitable actions and processes by loading the program 930 into the RAM 922.

Embodiments of this specification may be implemented by the program 930, so that the device 900 may perform any process discussed with reference to FIG. 2 to FIG. 7. Embodiments of this specification may alternatively be implemented by using hardware or a combination of software and hardware.

In some embodiments, the program 930 may be tangibly included in a computer-readable medium, and the computer-readable medium may be included in the device 900 (for example, in the memory 920) or another storage device that may be accessed by the device 900. The program 930 may be loaded from the computer-readable medium to the RAM 922 for execution. The computer-readable medium may include any type of tangible non-volatile memory, for example, a ROM, an EPROM, a flash memory, a hard disk, a CD, or a DVD.

Usually, various embodiments of this specification may be implemented by hardware or a dedicated circuit, software, logic, or any combination thereof. Some aspects may be implemented by hardware, and other aspects may be implemented by firmware or software, and may be performed by a controller, a microprocessor, or another computing device. Although various aspects of embodiments of this specification are shown and described as block diagrams or flowcharts, or represented by using some other figures, it should be understood that the blocks, apparatuses, systems, technologies, or methods described in this specification may be implemented as, for example, non-limiting examples, hardware, software, firmware, dedicated circuits or logic, general-purpose hardware, controllers, other computing devices, or a combination thereof.

This specification further provides at least one computer program product tangibly stored in a non-transitory computer-readable storage medium. The computer program product includes computer-executable instructions, such as instructions included in a program module, which are executed in a device on a target real or virtual processor to perform the processes/methods as described above with reference to FIG. 2 to FIG. 7. Usually, a program module includes a routine, a program, a library, an object, a class, a component, a data structure, and the like for executing a specific task or implementing a specific abstract data type. In various embodiments, functions of program modules may be combined or split between the program modules as required. Machine-executable instructions for the program module may be executed locally or in a distributed device. In the distributed device, the program module may be located in both local and remote storage media.

Computer program code used for implementing the method in this specification may be written in one or more programming languages. The computer program code may be provided to a processor of a general-purpose computer, a dedicated computer, or another programmable data processing apparatus, so that when the program code is executed by the computer or the another programmable data processing apparatus, functions/operations specified in the flowcharts and/or block diagrams are implemented. The program code may be executed all on a computer, partially on a computer, as an independent software package, partially on a computer and partially on a remote computer, or all on a remote computer or server.

In the context of this specification, the computer program code or related data may be carried on any proper carrier, so that the device, the apparatus, or the processor can perform various processing and operations described above. Examples of the carrier include a signal, a computer-readable medium, and the like. Examples of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus or device, or any suitable combination thereof. More detailed examples of the computer-readable storage medium include an electrical connection with one or more wires, a portable computer disk, a hard disk, a random access memory (RAM), a read-only memory (ROM), an erasable programmable read-only memory (EPROM or a flash memory), an optical storage device, a magnetic storage device, or any suitable combination thereof.

In addition, although the operations of the methods in this specification are described in a particular order in the accompanying drawings, this does not require or imply that these operations need to be performed in the particular order, or that all the operations shown need to be performed to achieve the desired results. Instead, the steps depicted in the flowchart may change an order of execution. Additionally or alternatively, some steps may be omitted, a plurality of steps are combined into one step for execution, and/or one step is decomposed into a plurality of steps for execution. It should further be noted that features and functions of two or more apparatuses according to this specification may be embodied in one apparatus. Instead, features and functions of one apparatus described above may be further embodied in a plurality of apparatuses.

Various implementations of this specification have been described above. The foregoing descriptions are example descriptions rather than exhaustive descriptions, and are not limited to the disclosed implementations. Without departing from the scope of the described implementations, many modifications and variations are apparent to a person of ordinary skill in the art. Selection of the terms used in this specification is intended to well explain principles, actual applications, or improvements to technologies in the market that are of various implementations, or to enable another person of ordinary skill in the art to understand the various implementations disclosed in this specification.

What is claimed is:

1. A method implemented by a first apparatus at a terminal side, comprising:
sending a first signal in response to the first apparatus discovering a target object, wherein the first signal is used to authenticate that the target object is sensed;
receiving a second signal, wherein the second signal indicates sensing permission information of the target object; and
sensing, the target object when the terminal device is authenticated to sense the target object.

2. The method according to claim 1, where the first signal is an excitation signal.

3. The method according to claim 1, further comprising:
sending a third signal to a second communication apparatus, wherein the third signal is used to request the second communication apparatus to send a signal to a first communication apparatus comprised in the target object, and the second communication apparatus and the first communication apparatus are at different locations.

4. The method according to claim 3, further comprising:
receiving, from the second communication apparatus, a third signal acknowledging the request.

5. The method according to claim 1, where the second signal is a feedback signal associated with the first signal.

6. The method according to claim 3, further comprising:
sending a fourth signal to the second communication apparatus, wherein the fourth signal indicates the second communication apparatus to stop sending the first signal.

7. The method according to claim 3, wherein a difference between a sending angle of the excitation signal for the first communication apparatus and a receiving angle of a reflected signal for a sensing signal used to sense the target object is less than a predetermined value.

8. The method according to claim 1, wherein the first signal is periodically sent or continuously sent during a period when the first apparatus senses the target object.

9. An apparatus, comprising:
one or more processors; and
an interface coupled with the one or more processors,
wherein the interface is configured to
send a first signal in response to the apparatus discovering a target object, and wherein the first signal is used to authenticate that the apparatus senses the target object; and
receive a second signal, wherein the second signal indicates sensing permission information of the target object, and
wherein the one or more processors are configured to
determine, based on the sensing permission information, whether the apparatus is authenticated to sense the target object; and
sense the target object when the apparatus is authenticated to sense the target object.

10. The apparatus according to claim 9, wherein the first signal is an excitation signal.

11. The apparatus according to claim 9, wherein the one or more processors are further configured to:
send a third signal to a second communication apparatus, wherein the third signal is used to request the second communication apparatus to send a signal to a first communication apparatus comprised in the target object, and the second communication apparatus and the first communication apparatus are at different locations.

12. The apparatus according to claim 11, wherein the one or more processors are further configured to:
receive, from the second communication apparatus, a third signal acknowledging the request.

13. The apparatus according to claim 11, wherein the second signal is a feedback signal associated with the first signal.

14. The apparatus according to claim 11, wherein the interface is further configured to send a fourth signal to the second communication apparatus, wherein the fourth signal indicates the second communication apparatus to stop sending the first signal.

15. The apparatus according to claim 11, wherein a difference between a sending angle of the excitation signal for the first communication apparatus and a receiving angle of a reflected signal for a sensing signal used to sense the target object is less than a predetermined value.

16. The apparatus according to claim 9, wherein the first signal is periodically sent or continuously sent during a period when the apparatus senses the target object.

17. A non-transitory computer-readable medium, storing computer programming instructions, that when executed by one or more processors of an apparatus, cause the apparatus to:
send a first signal in response to the apparatus discovering a target object, wherein the first signal is used to authenticate that the apparatus senses the target object;
receive a second signal, wherein the second signal indicates sensing permission information of the target object; and
determine, based on the sensing permission information, whether the apparatus is authenticated to sense the target object; and sense the target object when the apparatus is authenticated to sense the target object.

18. The non-transitory computer-readable medium according to claim 17, wherein the first signal is an excitation signal.

19. The non-transitory computer-readable medium according to claim 17, wherein the computer programming instructions are further executed by the one or more processors of the apparatus to cause the apparatus to:
send a third signal to a second communication apparatus, wherein the third signal is used to request the second communication apparatus to send a signal to a first communication apparatus comprised in the target object, and the second communication apparatus and the first communication apparatus are at different locations.

20. The non-transitory computer-readable medium according to claim 19, wherein the apparatus computer programming instructions are further executed by the one or more processors of the apparatus to cause the apparatus to:
receive, from the second communication apparatus, a third signal acknowledging the request.
